(19) United States
(12) Patent Application Publication
(10) Pub. No.: US 2014/0165903 A1
(43) Pub. Date: Jun. 19, 2014

(54) POINTER CAP FOR CLUSTER GAUGE

(71) Applicant: Continental Automotive Systems, Inc., Auburn Hills, MI (US)

(72) Inventors: Vyacheslav B. Birman, Auburn Hills, MI (US); Jeremy Rooney, Waterford, MI (US)

(73) Assignee: Continental Automotive Systems, Inc., Auburn Hills, MI (US)

(21) Appl. No.: 14/083,653

(22) Filed: Nov. 19, 2013

Related U.S. Application Data
(60) Provisional application No. 61/738,427, filed on Dec. 18, 2012.

(51) Int. Cl. G01D 13/22

(52) U.S. Cl. CPC G01D 13/22
USPC 116/28 R; 29/428

(57) ABSTRACT

A gauge assembly is disclosed and includes a gauge surface including graphics representing a vehicle operating parameter and a pointer supported for movement about an axis to indicate a current condition of the vehicle operating parameter by pointing to a specific location on the gauge surface. A cap mounted to the pointer along the axis is formed from a plastic film material different than the material forming the pointer.

### CROSS REFERENCE TO RELATED APPLICATION

This application claims priority to U.S. Provisional Application No. 61/738,427 filed on Dec. 18, 2012.

### TECHNICAL FIELD

The present disclosure relates to vehicle instrument panels and clusters, and more specifically to a pointer for a gauge that includes an improved pointer cap and method of mounting the pointer cap to a pointer.

### BACKGROUND

Vehicles include instrument panels to communicate information indicative of operation to an operator. Motor vehicles include instrument panels with several gauges and dials that communicate vehicle conditions such as speed, engine rpm, temperature, oil pressure along with many other operational parameters. A pointer is typically provided that rotates about a fixed axis to communicate current values of an operational parameter. Pointers are often illuminated to further enhance visibility. Light sources that direct light along the axis or rotation can cause a bright spot at the axis on the pointer. The bright spot is shielded by a pointer cap. The pointer cap typically includes press fit pins that are received within the corresponding parts of the pointer. The fit between the pointer and the pins of the cap must be maintained within predefined tolerances to assure a proper desired fit. The pointer and cap are typically molded parts, and the additional features can complicate molding operations and design.

Accordingly, it is desirable to design and develop a pointer and cap that reduce cost while maintaining the desired appearance and function.

### SUMMARY

A gauge assembly according to an exemplary embodiment of this disclosure, among other possible things includes a pointer assembly that rotates about an axis A. The pointer assembly includes a pointer, a pointer cap and a pointer shroud.

Light is communicated to a reflective surface of the pointer and directed into a pointer needle. Some of the light is reflected through the first reflecting surface and may create a bright spot that is not desirable and, therefore, the pointer cap is provided and attached to the pointer. The cap blocks light to prevent bright spots from being visible to an operator. A shroud is assembled to a bottom portion of the pointer to further block and shield light that may be emitted in a direction that is not desirable. The example pointer cap and the pointer shroud are fabricated from a thin film material or applique to provide a substantially thin and lightweight structure.

The thin film material simplifies assembly and provides for the use of adhesive for mounting to the pointer. Moreover, the use of the film material allows for the simplified printing of a graphic symbol on the cap that would not be feasible or practical for the use of other more rigid materials.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example instrument panel for a motor vehicle.

FIG. 2 is a cross-section of an example gauge.

FIG. 3 is a cross-sectional view through a pointer assembly for the example gauge.

FIG. 4 is an exploded view of the pointer assembly.

FIG. 5 is a schematic view of a method of assembling an example gauge assembly.

### DETAILED DESCRIPTION

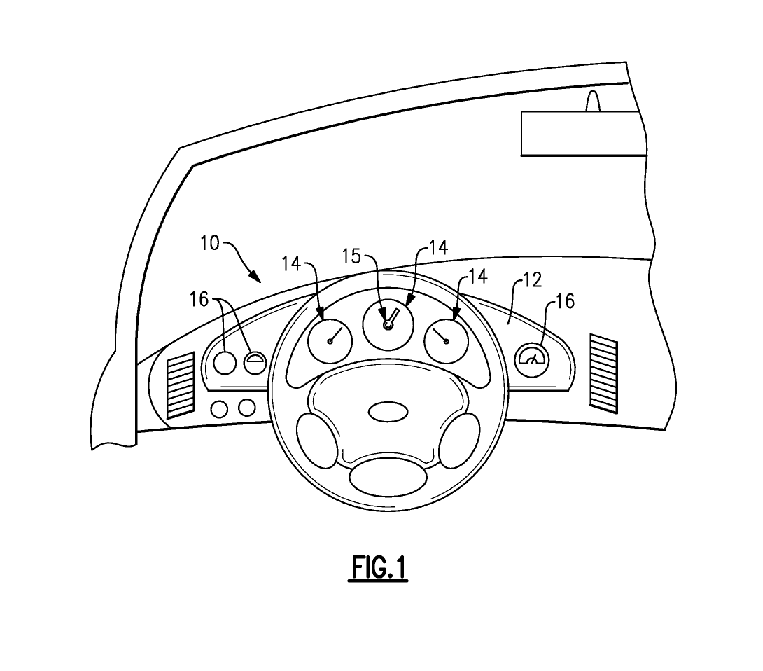

FIG. 1 schematically illustrates a dashboard 10 for a motor vehicle. The dashboard 10 includes an instrument panel 12 that includes a plurality of gauges 14 and dials 16. The gauges 14 communicate information indicative of vehicle operating parameters to vehicle operator. A pointer assembly 15 is included for the gauge 14 that rotates about an axis A to point to a specific portion of the graphics provided in each of the gauges 14 to indicate a current value of an operating condition.

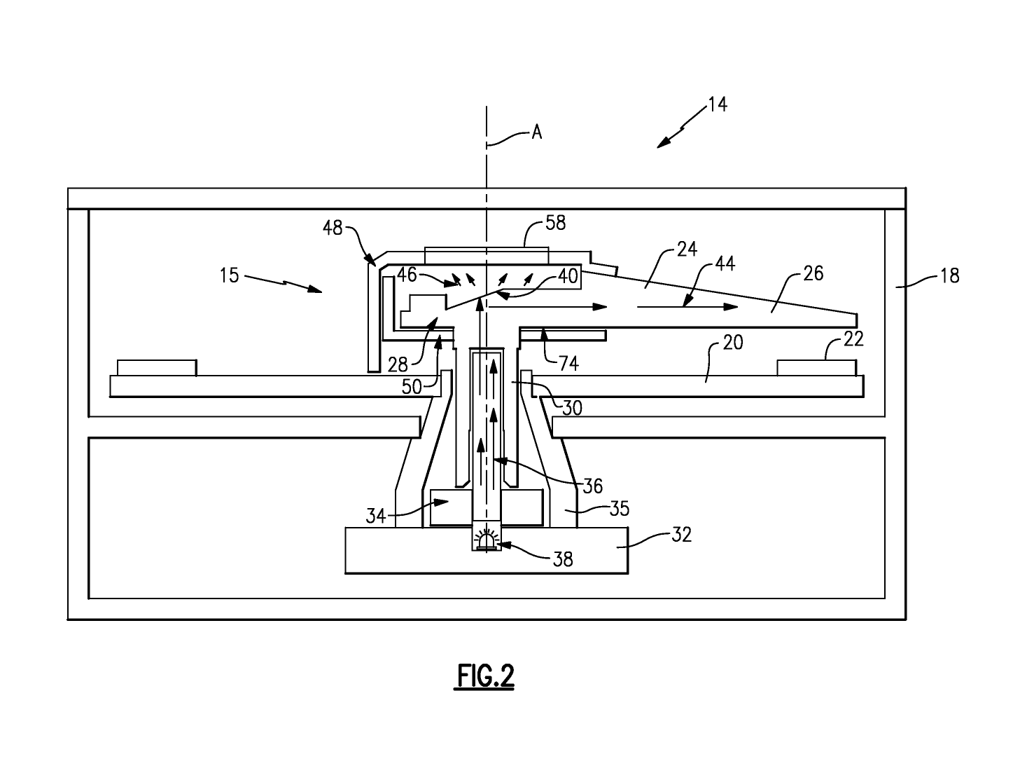

Referring to FIG. 2, the example gauge 14 includes the pointer assembly 15 that rotates about an axis A. The pointer assembly 15 includes a pointer 24, a pointer cap 48 and a pointer shroud 50. The pointer assembly 15 rotates about the axis A and points to specific graphics 22 that are supported on a gauge surface 20.

The gauge surface 20 is supported within a housing 18. The housing 18 also supports a printed circuit board 32 and a stepper motor 34. The stepper motor 34 is housed and supported on the circuit board 32 along with a light source 38. The stepper motor 34 rotates a clear shaft 36 about the axis A. In this example, the shaft 36 is transparent to allow for the propagation of light emitted from the light source 38. Although the example stepper motor 34 and light source 38 are shown supported on a common circuit board 32, they may be orientated and supported within the housing 18 by different structures. A light housing 35 blocks light propagation to the outer surface surrounding the light source 38.

Light from the light source 38 is transmitted through the stepper motor shaft 36 into a pointer shaft 30. Light enters the pointer shaft 30 and a portion of the pointer body 28 that includes a first reflective surface 40. Light 44 communicated to the first reflective surface 40 are directed into the pointer needle 26. Some of the light 46 is reflected through the first reflecting surface 40. The light 46 reflected through the first reflective surface 40 can create a bright spot that is not desirable and, therefore, the pointer cap 48 is provided and attached to the pointer 24.

The cap 48 blocks light transmitted along the axis A to prevent bright spots from being visible to an operator. A shroud 50 is assembled to a bottom portion of the pointer 24 to further block and shield light that may be emitted in a direction that is not desirable.

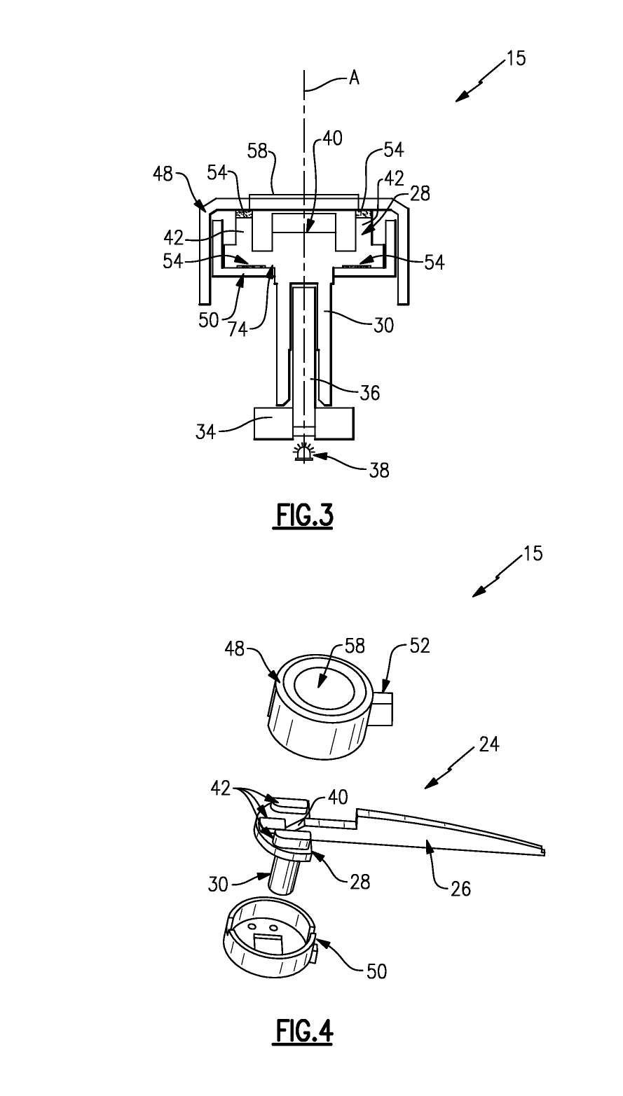

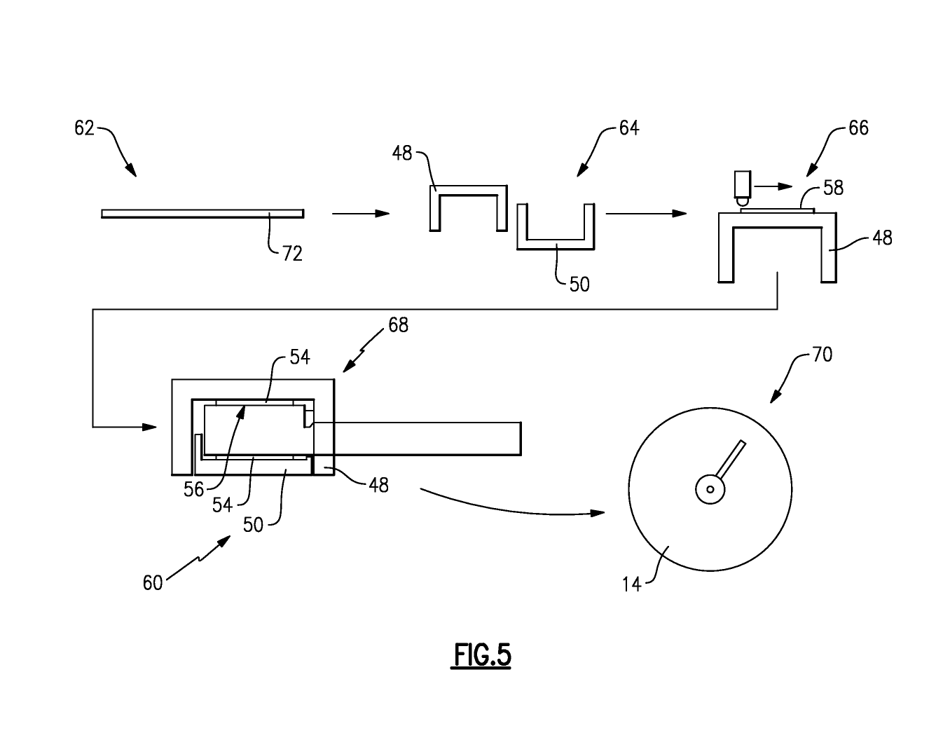

Referring to FIGS. 3 and 4 with continued reference to FIG. 2, the example pointer assembly 15 includes the pointer cap 48 and the pointer shroud 50. The pointer cap 48 is fabricated from a thin film material or applique to provide a substantially thin and lightweight cap 48. The pointer shroud 50 disposed on a bottom surface 74 of the pointer 24 is also fabricated from a thin film material. The film material may be common to or similar to the material utilized for fabricating the gauge surface 20. Moreover, the film material may be translucent to provide for the propagation of light to a printed graphic. The film material may also reflective to block light propagation.

In this example, both the cap 48 and the shroud 50 are fabricated from a polycarbonate film material to provide a substantially thin lightweight cap 48 and shroud 50. The cap 48 is attached to the pointer 24 through the use of an adhesive material 54.

The adhesive material 54 is applied to a pointer surface 56 and adheres the cap 48 to the pointer 24. The shroud 50 is also mounted to the pointer 24 with adhesive 54. The cap 48 is adhered to surfaces 42 disposed on the pointer body 28.

Previous configurations included press fit pins that fit into openings defined within the pointer. These pins required substantially rigid tolerances and were susceptible to breakage. Moreover, the pins required the fabrication of the cap 48 from more expensive materials. Accordingly, the use of a polycarbonate film simplifies assembly and attachment of the cap 48 and the shroud 50 to the pointer 24.

In one example, the polycarbonate cap 48 further provides a feature that is not feasible when other more expensive materials are utilized. In this example, the cap 48 includes a printed graphic portion 58 that is illuminatable by light communicated through the pointer 24. The graphic 58 can be printed on the polycarbonate film material to provide an illuminatable graphic or design within the cap 48.

Referring to FIG. 5 with continued reference to FIGS. 3 and 4, a method of assembly of the pointer 15 and gauge assembly 14 is schematically disclosed and includes an initial step of providing a polycarbonate film sheet material 72. The polycarbonate material is easily formed through thermal forming and other known manufacturing processes that are relatively inexpensive and reduce complexity and cost.

The polycarbonate film material 72 in this example is thermal formed as is schematically indicated at 64 to provide the desired shape of the cap 48 and the corresponding shroud 50. A thermal forming process may be executed as is known by those skilled in the art.

In this example, the cap 48 is then moved to a processing station 66 where a graphic symbol 58 is printed to a visible surface. The film material utilized for this example is translucent and provides for the propagation of light through a printed graphic symbol 58. The graphic printing process can be utilized as is known in the art and is simplified by the use of the polycarbonate film material 72.

Once the cap 48 and shroud 50, they may be assembled to the pointer 24. Because the polycarbonate film material is substantially lightweight, it may be attached to the pointer 24 using simplified techniques. In this example, the simplified technique includes application of an adhesive 54 to adhere the cap 48 to surfaces 56 of the pointer 24.

The shroud 50 is similarly attached to the bottom surface 74 of the pointer 24. The adhesive utilized for attaching the polycarbonate cap 48 and shroud 50 are as known in the art and do not require special characteristics as the use of the polycarbonate material simplifies this assembly and attachment process. Moreover, the use of the adhesive material simplifies the attachment configuration by eliminating the need for specially formed and molded mating features. All that is required is that the pointer assembly includes the flat surface 56 for receiving adhesive 54 and the corresponding cap 48. Once the cap and pointer assembly 24 are complete, they may be assembled into the gauge assembly 14 as is indicated at 70.

Accordingly, the example pointer assembly 15 includes a polycarbonate cap and shroud that simplifies assembly and allows for the use of adhesive for mounting to the pointer. Moreover, the use of the film material allows for the simplified printing of a graphic symbol on the cap that would not be feasible or practical for the use of other more rigid materials.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A gauge assembly comprising:
a gauge surface including graphics representing a vehicle operating parameter;
a pointer supported for movement about an axis to indicate a current condition of the vehicle operating parameter by pointing to a specific location on the gauge surface;
a cap mounted to the pointer along the axis formed from a plastic film material different than the material forming the pointer; and
an adhesive securing the cap to the pointer.

2. The gauge assembly as recited in claim 1, wherein the film material is similar material utilized for forming the gauge surface.

3. The gauge assembly as recited in claim 1, wherein the film material comprise a polycarbonate material.

4. The gauge assembly as recited in claim 1, including a printed graphic on the cap.

5. The gauge assembly as recited in claim 4, including a light source propagating light to the pointer and the printed graphic is illuminatable by light propagated through the pointer.

6. The gauge assembly as recited in claim 1, including a stepper motor having a clear shaft supporting rotation of the pointer, wherein the clear shaft propagates light to at least one reflective surface of the pointer.

7. The gauge assembly as recited in claim 6, wherein the at least one reflective surface comprise a central light reflecting surface for directing light into a pointer arm and at least one secondary light reflecting surface for directing light utilized for illuminating a graphic disposed on the cap.

8. The gauge assembly as recited in claim 1, including a pointer shroud formed from the film material mounted to a bottom surface of the pointer.

9. A method of assembling a gauge assembly comprising:
forming a gauge surface to include a graphic representing a vehicle operating parameter;
assembling a pointer to a rotating shaft for rotation about an axis relative to the gauge surface;
forming a cap from a film material; and
attaching the cap to the pointer.

10. The method as recited in claim 9, including attaching the cap to the pointer by applying an adhesive to a surface of the pointer and adhering the cap to the surface of the pointer with the adhesive material.

11. The method as recited in claim 9, including forming the cap from a polycarbonate film material.

12. The method as recited in claim 9, including printing a graphic on the cap.

13. The method as recited in claim 12, including defining at least one reflective surface in the pointer for communicating light to the graphic on the cap.

14. The method as recited in claim 9, including mounting a pointer shroud to a lower surface of the pointer.

15. The method as recited in claim 9, including assembling the pointer to a clear shaft for propagating light from a light source below the gauge surface to the pointer.
